(19) United States
(12) Patent Application Publication
(10) Pub. No.: US 2018/0345456 A1
(43) Pub. Date: Dec. 6, 2018

(54) HANDHELD, HAND-GUIDED CUTTING-OFF MACHINE

(71) Applicant: Hilti Aktiengesellschaft, Schaan (LI)

(72) Inventors: Ralf GREITMANN, Kaufering (DE); Guenther VEIK, Maeder (AT); Helmut SPECHT, Bad Woerishofen (DE)

(21) Appl. No.: 15/778,843

(22) PCT Filed: Nov. 16, 2016
(86) PCT No.: PCT/EP2016/077831

§ 371 Date: May 24, 2018

(30) Foreign Application Priority Data
Nov. 25, 2015 (EP) 15196161.2

(51) Int. Cl. B24B 55/05; B23Q 11/06; B24B 23/02; B24B 27/08

(52) U.S. Cl. CPC B24B 55/052; B24B 27/08; B24B 23/02; B23Q 11/06

(57) ABSTRACT

A handheld, hand-guided cutting-off machine, which includes a rotating cutting-off wheel, a supporting housing part (36), an output shaft (20), which is rotatably supported around an output axis (40), a drive motor, a transmission mechanism (19), which connects the drive motor to the output shaft (20), a flange (41) and a safety guard (24), which covers the cutting-off wheel over a covering area (25). The cutting-off wheel is rotatably fixedly mounted on the output shaft (20) with the aid of the flange (41) and surrounded by the safety guard (24). The safety guard (24) is pivotable around a pivot axis, and the pivot axis is displaced by a distance from the output axis (40) of the output shaft (20).

The present invention relates to an expansion dowel that includes at least one dowel body, preferably an expansion sleeve, as a first element and at least one bolt as a second element, the bolt including an expansion body, preferably an expansion cone, that pushes the dowel body radially outwardly when the expansion body is moved in an extraction direction relative to the dowel body.

The present invention relates to a handheld, hand-guided cutting-off.

### BACKGROUND

Cutting-off machines are handheld, hand-guided power tools, which include a machining tool designed in the form of a rotating cutting-off wheel. The key components of a cutting-off machine include, in addition to the cutting-off wheel, a supporting housing part, an output shaft, which is rotatably supported around an output axis, a drive motor, a transmission mechanism, which connects the drive motor to the output shaft, a flange and a safety guard, which covers the cutting-off wheel over a covering area. The cutting-off wheel is rotatably fixedly mounted on the output shaft with the aid of the flange and surrounded by the safety guard, which is pivotably supported around a pivot axis. The pivot axis of the safety guard is situated coaxially to the output axis, which corresponds to the rotation axis of the cutting-off wheel. DE 10 2005 049 766 B4 discloses a handheld, hand-guided cutting-off machine of this type.

The European standard EN ISO 19432:2012 and the U.S. standard ANSI B175.4-2013 define safety requirements and measures for testing the structural design of handheld, hand-guided cutting-off machines, which include a built-in combustion motor for one-man operation and are designated for cutting building materials, for example asphalt, concrete, stone and metal, and which apply to cutting-off machines which are provided for use with a rotating cutting-off wheel having cutting-off bodies made of bound abrasive material and/or grinding tools having diamond or CBN abrasive materials, which are mounted centrally on a spindle shaft and are driven thereby, the front face of the cutting-off wheel rotating in a direction facing away from the user. The standards define a minimum flange diameter for the flange, depending on the type and wheel diameter of a cutting-off wheel. With regard to the type of cutting-off wheels, a distinction is made between diamond cutting-off wheels and abrasive cutting-off wheels, and with regard to wheel diameter D of the cutting-off wheels, a distinction is made between four ranges (D≤250 mm, 250 mm<D≤300 mm, 300 mm<D≤350 mm and 350 mm<D). The European standard EN ISO 19432:2012 applies to cutting-off wheels having a maximum wheel diameter of 400 mm, and the US standard ANSI B175.4-2013 applies to cutting-off wheels having a maximum wheel diameter of 406 mm.

The European standard EN IEC 60745-2-22:2011 and the U.S. standard ANSI/UL 60745-2-22-2012 apply to hand-guided, motor-operated electric power tools in the form of cutting-off machines, which are provided with a rotating cutting-off wheel having wheel diameters from 55 mm to 410 mm for cutting off materials such as metal, concrete, masonry, glass and tile. The standards define a minimum flange diameter for the flange, depending on the type, wheel diameter D and bore diameter Ø of a cutting-off wheel. Regarding the type of cutting-off wheels, a distinction is made between diamond cutting-off wheels and bound, reinforced cutting-off wheels of type 41 or 42. Minimum flange diameter dₘᵢₙ is dₘᵢₙ=0.15*D for diamond cutting-off wheels having a wheel diameter D of 55 mm≤D≤410 mm. For bound, reinforced cutting-off wheels of type 41 or 42, a distinction is made between four ranges for wheel diameter D (55 mm≤D<80 mm, 80 mm≤D<105 mm, 105 mm≤D≤230 mm and 230 mm<D≤410 mm), and a distinction is made between bore diameters Ø of 10 mm and 16 mm for wheel diameter D where 80 mm≤D<105 mm.

The maximum cutting depth achievable by a cutting-off wheel in a workpiece is defined by half the difference between the wheel diameter of the cutting-off wheel and the assigned minimum flange diameter of the flange. In practice, diamond cutting-off wheels having wheel diameters of 300 mm and 350 mm are primarily used in cutting-off machines which include a combustion motor. The maximum cutting depth achievable by a diamond cutting-off wheel having a wheel diameter of 300 mm is 127.5 mm, and the maximum cutting depth achievable by a diamond cutting-off wheel having a wheel diameter of 350 mm is 148.75 mm.

The actual cutting depths achievable by known cutting-off machines in a workpiece are less than the specified maximum cutting depths defined by half the difference between the wheel diameter and the minimum flange diameter. The equipment manufacturer Stihl offers different gas-powered cutting-off machines, the cutting-off machines TS 400, TS 410 and TS 420, among others. The TS 400 cutting-off machines are provided for diamond cutting-off wheels and may be operated with different wheel diameters of 300 mm and 350 mm. According to the manufacturer's information, the cutting depth achievable by the TS 400 cutting-off machine with a wheel diameter of 300 mm is 100 mm, and according to the manufacturer's information, the maximum cutting depth achievable by the TS 400 cutting-off machine with a wheel diameter of 350 mm is 125 mm. The TS 410 cutting-off machines are provided for diamond cutting-off wheels having a wheel diameter of 300 mm, and the TS 420 cutting-off machines are provided for diamond cutting-off wheels having a wheel diameter of 350 mm. According to the manufacturer's information, the cutting depth achievable by the TS 410 cutting-off machine is 100 mm, and according to the manufacturer's information, the maximum cutting depth achievable by the TS 420 cutting-off machine is 125 mm.

The cutting depths achievable by the TS 400 cutting-off machine with a wheel diameter of 300 mm and the TS 410 cutting-off machine are 20% less than the maximum cutting depth of 127.5 mm, and the cutting depths achievable by the TS 400 cutting-off machine with a wheel diameter of 350 mm and the TS 420 cutting-off machine are approximately 16% less than the maximum cutting depth of 148.75 mm. The flanges which Stihl uses in the TS 400, TS 410 and TS 420 cutting-off machines have a flange diameter of at least 103 mm. In the TS 400 cutting-off machines, which may be operated with different wheel diameters of 300 mm and 350 mm, the same flange diameter of at least 103 mm is provided for the different wheel diameters. The flange diameters used are much larger than minimum flange diameter dₘᵢₙ, which the European standard EN ISO 19432:2012 and the U.S. standard ANSI B175.4-2013 require for diamond cutting-off wheels having a wheel diameter of 300 mm (dₘᵢₙ 45 mm) and a wheel diameter of 350 mm (dₘᵢₙ 52.5 mm). The standards apply to cutting-off machines which were manufactured on or after the publication date of the standards and not to cutting-off machines which were manufactured before the publication date of the standards. The previous versions of the standards have also defined the same minimum flange diameters of 45 mm and 52.5 mm for diamond cutting-off wheels having wheel diameters of 300 mm and 350 mm.

### SUMMARY OF THE INVENTION

It is an object of the present invention to further develop a handheld, hand-guided cutting-off machine in such a way that the cutting depth achievable with a cutting-off wheel in a workpiece is increased compared to the known cutting-off machines, and preferably the maximum cutting depth is achieved, which is defined by half the difference between the wheel diameter of the cutting-off wheel and the minimum flange diameter of the flange.

According to the present invention, the handheld, hand-guided cutting-off machine is characterized in that the pivot axis of the safety guard is displaced by a distance from the output axis of the output shaft. In a safety guard designed to be pivotable around a pivot axis, another bearing element is required for the pivotable support of the safety guard. By displacing the pivot axis with respect to the output axis, the components of the cutting-off machine situated in the area of the output shaft may be better distributed in the available space and the cutting depth thereby increased. The components situated in the area of the output shaft include a bearing for the output shaft, the safety guard, the supporting housing part and the transmission mechanism.

The cutting depth achievable by a cutting-off wheel in a workpiece is specified by half the difference between the wheel diameter of the cutting-off wheel used and the flange diameter of the flange used, this cutting depth being achieved only if no components of the cutting-off machine additionally limit the cutting depth. The safety guard is made up of the covering area, which covers the cutting-off wheel, and the machining area, which exposes the cutting-off wheel for machining a workpiece. A receiving area available for arranging and supporting the components (safety guard, supporting housing part and transmission mechanism) is defined by the flange having the flange diameter in the machining area of the safety guard. If the cutting-off machine is to achieve the cutting depth defined by half the difference between the wheel diameter of the cutting-off wheel used and the flange diameter of the flange used, all components of the cutting-off machine must be transferred to the receiving area over a limited angle range.

To increase the cutting depth of a cutting-off wheel, a flange having a preferably small flange diameter is used. The smaller the flange diameter is selected, the smaller is the receiving area for arranging and supporting the components. An optimum arrangement of the components is therefore particularly important if a preferably small flange diameter is to be used. The support of the safety guard is particularly critical. The safety guard includes a fastening flange, which is connected to a side wall of the safety guard. The fastening flange is mounted on a matching counter-contour of the supporting housing part and is designed to be adjustable around the pivot axis with respect to the counter-contour. If the pivot axis of the safety guard coincides with the output axis of the output shaft, the diameter of the fastening flange is limited by the flange diameter. Due to the displacement of the pivot axis, the diameter of the fastening flange may be selected to be larger than the flange diameter.

The pivot axis of the safety guard is particularly preferably displaced with respect to the output axis of the output shaft in the covering area of the safety guard. The safety guard is made up of the covering area, which covers the cutting-off wheel, and the machining area, which exposes the cutting-off wheel for machining a workpiece. To achieve a preferably great cutting depth with the aid of a cutting-off wheel, a flange having a preferably small flange diameter is used. The smaller the flange diameter is selected, the smaller the receiving area for the arrangement and support of the components (bearing for the output shaft, safety guard, supporting housing part and transmission mechanism), the support of the safety guard being particularly critical. The diameter of the fastening flange is a variable which is essentially defined by the size and weight of the safety guard in pivotable safety guards which are adjustable via frictional engagement. Due to the displacement of the pivot axis into the covering area of the safety guard, the diameter of the fastening flange may be selected to be larger than the flange diameter of the flange used.

The safety guard particularly preferably includes a fastening flange having a diameter, and the distance between the pivot axis and the output axis is greater than or equal to half the difference between the diameter of the fastening flange and the flange diameter. The fastening flange is the subcomponent of the safety guard, over which the safety guard is designed to be pivotable. The fastening flange is mounted on a matching counter-contour of the supporting housing part and is designed to be adjustable around the pivot axis with respect to the counter-contour. The diameter of the fastening flange is a variable which is essentially defined by the size and weight of the safety guard. If the distance between the pivot axis and the output axis is selected to be greater than or equal to half the difference between the diameter of the fastening flange and the flange diameter, the fastening flange of the safety guard in the outcut angle is within the receiving area defined by the flange having the flange diameter.

In one preferred specific embodiment, the safety guard, the supporting housing part and the transmission mechanism have maximum distances from the output axis over an outcut angle, which are smaller than half the flange diameter or equal to half the flange diameter. The outer delimitations of the components of the cutting-off machine which are designed as the safety guard, supporting housing part and transmission mechanism are referred to as outer contours, and the distances from the output axis correspond to the maximum distances of the outer contours from the output axis in the outcut angle; outside the outcut angle, the distances of the outer contours from the output axis are greater than or equal to half the flange diameter. Due to the fact that the outer contours of the components of the cutting-off machine in the outcut angle are designed in such a way that their distances from the output axis are less than half the flange diameter or equal to half the flange diameter, the cutting depth defined by half the difference between the wheel diameter and the flange diameter is achievable in the outcut angle. The cutting depth of the cutting-off machine according to the present invention is increased in the outcut angle compared to the known cutting-off machines.

The transmission mechanism preferably includes an output disk, which is situated on the output shaft, and a transmission element, which transmits a movement of the drive motor to the output disk, the output disk, the output disk and the transmission element having maximum distances from the output axis over the outcut angle, which are less than or equal to half the flange diameter. The transmission mechanism is one of the components of the cutting-off machine which are situated in the outcut angle. The condition that the maximum distance of the transmission mechanism from the output axis is less than or equal to half the minimum flange diameter in the outcut angle must be met for all subcomponents of the transmission mechanism. These include the output disk, which is situated on the output shaft, and the transmission element, which is situated on the output disk. The output disk has a fourth maximum distance from the output axis, and the transmission element has a fifth maximum distance from the output axis.

The transmission mechanism particularly preferably includes a cover, the cover having a maximum distance from the output axis over the outcut angle, which is less than or equal to half the flange diameter. The subcomponents of the transmission mechanism which are designed as the output disk and the transmission element are rotating components, which must be covered to meet safety requirements. The cover has a sixth maximum distance from the output axis.

In one preferred refinement of the cutting-off machine according to the present invention, the flange diameter of the flange corresponds to a minimum flange diameter. The flange diameters which are specified as the lower limiting values for the flange in the particular, applicable standards are defined as minimum flange diameters. Among other things, the minimum flange diameter is dependent on the type of drive motor, the type of cutting-off wheel and the wheel diameter of the cutting-off wheel. If the flange diameter of the flange used corresponds to the minimum flange diameter, the maximum cutting depth is achievable with a cutting-off wheel, the maximum cutting depth of a cutting-off wheel being specified by half the difference between the wheel diameter of the cutting-off wheel and the minimum flange diameter. The cutting-off machine according to the present invention has the advantage that the cutting depth is increased compared to the known cutting-off machines, and the maximum cutting depth is achieved. In the cutting-off machine according to the present invention, which includes a combustion motor and a diamond cutting-off wheel, a cutting depth is achieved with a wheel diameter of 300 mm, while a diamond cutting-off wheel having a wheel diameter of 350 mm is required for known gas-powered cutting-off machines, such as the TS 400 and TS 410 cutting-off machines of the Stihl company.

In a preferred first variant of the cutting-off machine according to the present invention, the drive motor is designed as a combustion motor, and the cutting-off wheel is designed as a diamond cutting-off wheel or as an abrasive cutting-off wheel. The European standard EN ISO 19432:2012 applies to gas-powered cutting-off machines in Europe, and the U.S. standard ANSI B175.4-2013 applies thereto in the United States. Comparable standards are valid in other countries or regions outside Europe and the United States, and the European standard may be implemented in national standards in European countries. In cutting-off machines according to the present invention which include a combustion motor and a diamond cutting-off wheel, minimum flange diameter dₘᵢₙ is: dₘᵢₙ=37.5 mm for D≤250 mm, dₘᵢₙ=45 mm for 250 mm<D≤300 mm, dₘᵢₙ=52.5 mm for 300 mm<D≤350 mm and dₘᵢₙ=60 mm for 350 mm<D. In cutting-off machines which include a combustion motor and an abrasive cutting-off wheel, minimum flange diameter dₘᵢₙ is: dₘᵢₙ=63.5 mm for D≤250 mm, dₘᵢₙ=75 mm for 250 mm<D≤300 mm, dₘᵢₙ=87.5 mm for 250 mm<D≤350 mm and dₘᵢₙ=100 mm for 350 mm<D.

A cutting-off machine according to the present invention which includes a combustion motor and a diamond cutting-off wheel achieves a maximum cutting depth of 106.25 mm (½*(250 mm−37.5 mm)) with a wheel diameter of 250 mm, a maximum cutting depth of 127.5 mm (½*(300 mm−45 mm)) with a wheel diameter of 300 mm, a maximum cutting depth of 148.75 mm (½*(350 mm−52.5 mm)) with a wheel diameter of 350 mm and a maximum cutting depth of 170 mm (½*(400 mm−60 mm)) with a wheel diameter of 400 mm. An abrasive cutting-off machine according to the present invention which includes a combustion motor and an abrasive cutting-off wheel, achieves a maximum cutting depth of 93.25 mm (½*(250 mm−63.5 mm)) with a wheel diameter of 250 mm, a maximum cutting depth of 112.5 mm (½*(300 mm−75 mm)) with a wheel diameter of 300 mm, a maximum cutting depth of 131.25 mm (½*(350 mm−87.5 mm)) with a wheel diameter of 350 mm and a maximum cutting depth of 150 mm (½*(400 mm−100 mm)) with a wheel diameter of 400 mm.

In a preferred second variant of the cutting-off machine according to the present invention, the drive motor is designed as an electric motor, and the cutting-off wheel is designed as a diamond cutting-off wheel or as a bound, reinforced cutting-off wheel of type 41 or 42. The European standard EN IEC 60745-2-22:2011 applies to cutting-off machines which include an electric motor in Europe, and the US standard ANSI/UL 60745-2-22-2012 applies thereto in the United States. Comparable standards are valid in other countries or regions outside Europe and the United States, and the European standard may be implemented in national standards in European countries. For cutting-off machines according to the present invention which include an electric motor and a diamond cutting-off wheel, minimum flange diameter dₘᵢₙ is: dₘᵢₙ=0.15*D for 55 mm≤D≤410 mm. For cutting-off machines according to the present invention which include an electric motor and a bound, reinforced cutting-off wheel of type 41 or 42, minimum flange diameter dₘᵢₙ is: dₘᵢₙ=19 mm for 55 mm≤D<80 mm, dₘᵢₙ=19 mm where 0=10 mm and dₘᵢₙ=28 mm where Ø=16 mm for 80 mm≤D<105 mm, dₘᵢₙ=40 mm for 105 mm≤D≤230 mm and dₘᵢₙ=0.25*D for 230 mm<D≤410 mm.

### BRIEF DESCRIPTION OF THE DRAWINGS

Exemplary embodiments of the present invention are described below on the basis of the drawing. The latter is not necessarily intended to represent the exemplary embodiments true to scale but rather the drawing is presented in a schematic and/or slightly distorted form where useful for the purpose of explanation. It should be taken into account that a variety of modifications and changes relating to the form and detail of a specific embodiment may be undertaken without deviating from the general idea of the present invention. The general idea of the present invention is not limited to the exact form or the detail of the preferred specific embodiment illustrated and described below, nor is it limited to an object which would be limited in comparison to the object claimed in the claims. In given measurement ranges, values within the specified limits are also to be disclosed as limiting values and be able to be arbitrarily used and claimed. For the sake of simplicity, the same reference numerals are used below for identical or similar parts or for parts having identical or similar functions.

FIGS. 1A, 1B show a handheld, hand-guided cutting-off machine, including a cutting-off wheel;

FIGS. 2A, 2B show a safety guard and a belt drive of the cutting-off machine illustrated in FIGS. 1A, 1B, including a cover (FIG. 2A) and without a cover (FIG. 2B);

FIGS. 3A through 3C show the cutting-off wheel and the safety guard of the cutting-off machine in FIG. 1A in a side view (FIG. 3A) as well as in a section along section line A-A (FIG. 3B) and in a second section along section line B-B (FIG. 3C);

FIG. 4 shows an enlarged detail of the second section in FIG. 3C; and

FIG. 5 shows the safety guard and a supporting arm housing of the belt drive, the cutting depth corresponding to the maximum cutting depth over an outcut angle.

### DETAILED DESCRIPTION

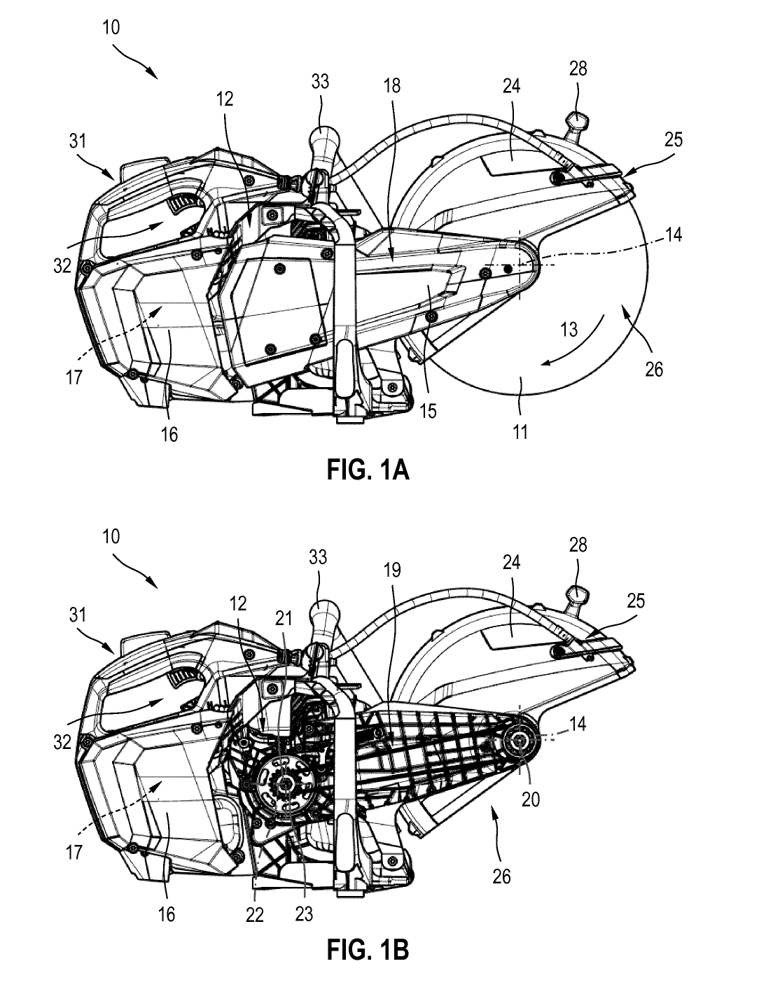

FIGS. 1A, 1B show a handheld, hand-guided power tool 10 according to the present invention, which is designed in the form of a cutting-off machine. Cutting-off machine 10 includes a machining tool designed as a cutting-off wheel 11, which is driven by a drive unit 12 in a rotation direction 13 around a rotation axis 14. All drive components for cutting-off wheel 11 are combined as drive unit 12. In cutting-off machine 10 illustrated in FIG. 1B, a cover 15 was removed, so that at least some drive components of drive unit 12 are visible. Cover 15 may have a single-part or multi-part design and is fastened to cutting-off machine 10 by screws.

Drive unit 12 includes a drive motor 17 situated in a motor housing 16, a transmission mechanism situated in a supporting arm 18 and designed as a belt drive 19, and an output shaft 20, on which cutting-off wheel 11 is mounted. Additional transmission components are connectable as needed between drive motor 17 and belt drive 19. A centrifugal clutch may be situated between drive motor 17 and belt drive 19, which ensures that cutting-off wheel 11 does not rotate at low rotational speeds, such as when idling or when starting cutting-off machine 10. The centrifugal clutch includes a clutch bell, against which the centrifugal weights are pressed outwardly during operation, due to the centrifugal force. Drive motor 17 drives a drive shaft 21 around a drive axis 22. The clutch bell of the centrifugal clutch is rotatably fixedly connected to a drive disk 23, which is rotatably supported on drive shaft 21.

Combustion motors or electric motors are used as drive motors 17 for cutting-off machine 10. All drive motors for motor-operated electric power tools are combined under the term “electric motor”; the electric power tools may be cable-bound with a direct connection to the grid or wireless without a direct connection to the grid. Cutting-off machines which include a combustion motor, may be used with different types of cutting-off wheels 11—diamond cutting-off wheels and abrasive cutting-off wheels—the cutting-off wheels including abrasive cutting-off bodies made of bound abrasive materials and/or grinding tools having diamond and CBN abrasive materials. Cutting-off machines which include an electric motor may be used with different types of cutting-off wheels 11: diamond cutting-off wheels and bound, reinforced cutting-off wheels of type 41 or 42.

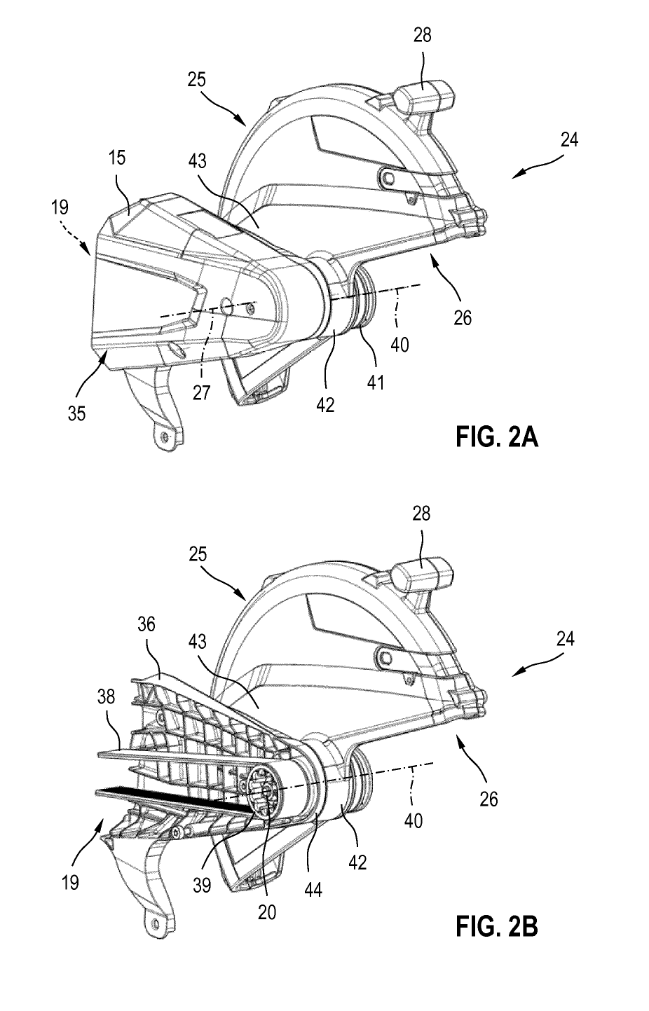

Cutting-off wheel 11 is surrounded by a safety guard 24, which is used to protect the operator against flying dust particles and also reduces the risk of injury by the operator reaching into rotating cutting-off wheel 11 during the operation of cutting-off machine 10. Safety guard 24 is fastened in a hub area of cutting-off wheel 11 and is made up of a covering area 25, which covers cutting-off wheel 11 over a covering angle of approximately 200°, and a machining area 26, which exposes cutting-off wheel 11 over a machining angle of 160° for machining a workpiece. Safety guard 24 is designed to be pivotable and may be pivoted around a pivot axis 27 (FIGS. 2A, 2B) into a desired pivot position. To set the pivot position, a hand grip element 28 is fastened to safety guard 24, which may be used to apply the necessary forces to pivot safety guard 24 around pivot axis 27.

A first handle 31, which has an operating unit 32 and is designed as a top handle, is provided for operating cutting-off machine 10. A handle which is situated above motor housing 16 is referred to as a top handle. Alternatively, the first handle may be designed as a rear handle, which is situated on the side of motor housing 16 facing away from cutting-off wheel 11. In addition to first handle 31, a second handle 33, which is situated between cutting-off wheel 11 and first handle 31, is provided for guiding cutting-off machine 10. In the exemplary embodiment shown in FIGS. 1A, 1B, second handle 33 is designed as a separate gripping tube, or it may be alternatively designed as a single piece with motor housing 16 or another housing part.

FIGS. 2A, 2B show an enlarged representation of safety guard 24 and belt drive 19 of cutting-off machine 10 from FIGS. 1A, 1B. Belt drive 19 is situated in a supporting arm housing 35, which includes a stationary, supporting housing part 36 and cover 15. FIG. 2A shows belt drive 19, including mounted cover 15, and FIG. 2B shows belt drive 19 without cover 15.

The drive of cutting-off wheel 11 takes place via drive motor 17, belt drive 19 and output shaft 20. Drive motor 17 may be designed as a combustion motor or as an electric motor. Drive motor 17 drives drive shaft 21 and drive disk 23 around drive axis 22. A transmission element 38 designed as a drive belt is guided via drive disk 23 and an output disk 39 supported on output shaft 20. Output shaft 20 is rotatable around an output axis 40, which coincides with rotation axis 14 of cutting-off wheel 11. Drive disk 23, drive belt 38 and output disk 39 form belt drive 19. Alternatively, transmission mechanism 19 may be designed, for example, in the form of a chain drive, in which the transmission element between drive disk 23 and output disk 39 is designed as a chain. Cutting-off wheel 11 is situated on output shaft 20 with the aid of a flange 41 and is rotatably fixedly connected to output shaft 20. Flange 41 and cutting-off wheel 11 are mounted on output shaft 20, and cutting-off wheel 11 is situated between two flange halves of flange 41.

A workpiece is machined with the aid of cutting-off machine 10 in the area of cutting-off wheel 11 situated in machining area 26 of safety guard 24. Safety guard 24 includes a fastening flange 42 in the hub area of cutting-off wheel 11, which, in the exemplary embodiment, is designed as a single piece with a side wall 43 of safety guard 24; alternatively, the fastening flange may also be designed as a separate part and connected to safety guard 24. Fastening flange 42 is mounted on a matching counter-contour 44 of the stationary housing part 36 and is designed to be adjustable with respect to counter-contour 44 of housing part 36. Safety guard 24 is designed to be pivotable around pivot axis 27 between a front pivot position and a rear pivot position. The pivot range of safety guard 24 is limited to an angle range of approximately 60°.

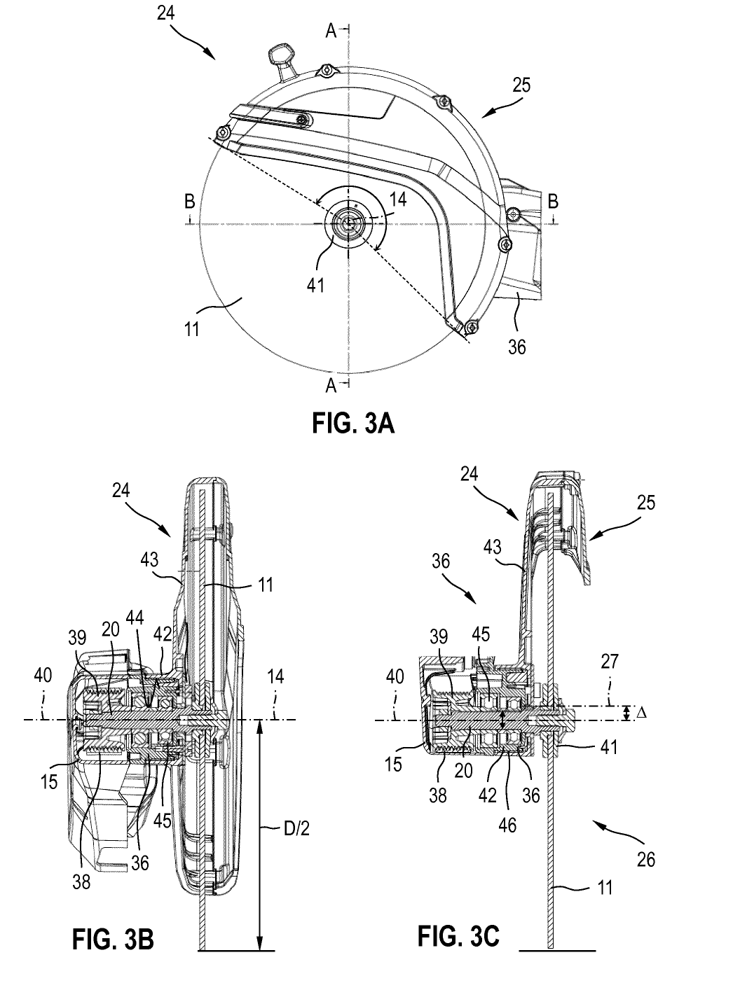

FIGS. 3A through 3C show an enlarged representation of cutting-off wheel 11 and safety guard 24 of cutting-off machine 10 from FIG. 1A. FIG. 3A shows the arrangement of cutting-off wheel 11 and safety guard 24 in a side view; FIG. 3B shows a section along section line A-A in FIG. 3A; and FIG. 3C shows a section along section line B-B in FIG. 3A. Cutting-off wheel 11 is fastened to output shaft 20 with the aid of flange 41 and is designed to be rotatable around rotation axis 14. The movement of drive motor 17 is transmitted to output shaft 20 via drive belt 38 and output disk 39, which is rotatably fixedly supported on output shaft 20.

Safety guard 24 is made up of the covering area 25, which covers cutting-off wheel 11, and machining area 26, which exposes cutting-off wheel 11 for machining a workpiece. The full angle of cutting-off wheel 11 of 360° is divided by safety guard 24 into a covering angle and a machining angle. Covering area 25 of safety guard 24 determines the covering angle, and machining area 26 of safety guard 24 determines the machining angle. In the exemplary embodiment, the covering angle is approximately 200°, and the machining angle is approximately 160°.

Output shaft 20 is supported on stationary housing part 36 via a bearing element 45. Safety guard 24 is fastened to stationary housing part 36. Fastening flange 42 of safety guard 24 is mounted on counter-contour 44 of housing part 36 and designed to be pivotable around pivot axis 27 relative to stationary housing part 36. To facilitate the pivoting movement of safety guard 24, a sliding element 46 is provided between fastening flange 42 and counter-contour 44, which reduces friction and is designed, for example, as a Teflon ring.

FIG. 3C shows pivot axis 27 of safety guard 24, which is different than output axis 40 of output shaft 20. Pivot axis 27 is displaced with respect to output axis 40 into covering area 25 of safety guard 24. In the exemplary embodiment, distance A between pivot axis 27 and output axis 40 is greater than half of diameter d of output shaft 20.

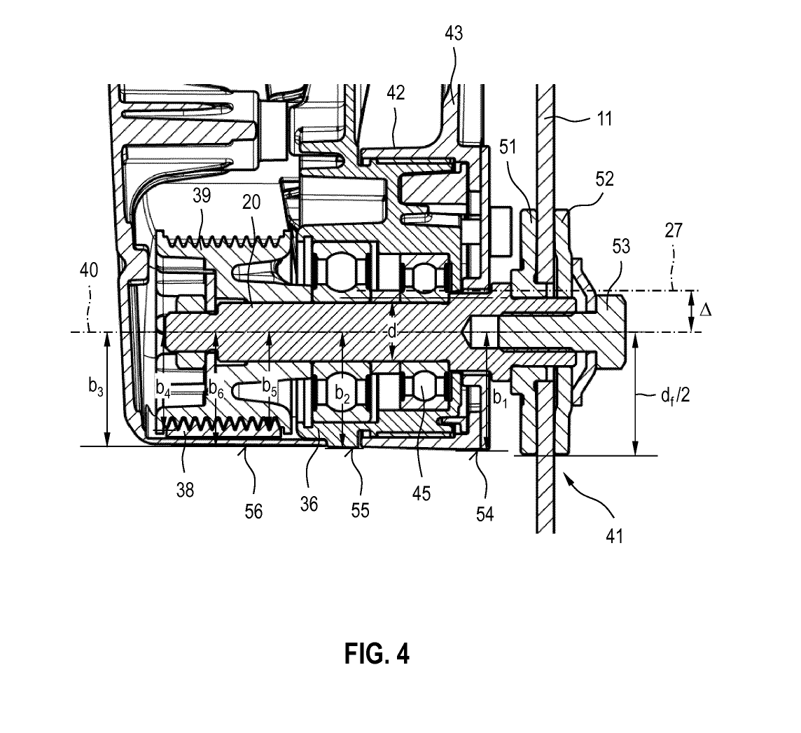

FIG. 4 shows an enlarged detail of the second section along section line B-B in FIG. 3A illustrated in FIG. 3C. The detail shows output shaft 20 and flange 41, with the aid of which cutting-off wheel 11 is fastened on output shaft 20.

Flange 41 has a multi-part design and includes a first flange part 51, a second flange part 52 and a tool screw 53. To assemble cutting-off wheel 11, first flange part 51 is mounted on or screwed to output shaft 20, cutting-off wheel 11 is mounted on first flange part 51, and second flange part 52 is mounted. Cutting-off wheel 11 is clamped between first and second flange halves 51, 52 with the aid of tool screw 53.

For gas-powered cutting-off machines, the European standard EN ISO 19432:2012, the U.S. standard ANSI B175.4-2013 and corresponding standards in other countries define a minimum flange diameter dₘᵢₙ for flange 41, depending on the type of cutting-off wheel 11 (diamond cutting-off wheel or abrasive cutting-off wheel) and on wheel diameter D of cutting-off wheel 11 (D≤250 mm, 250 mm<D≤300 mm, 300 mm<D≤350 mm and 350 mm<D). For diamond cutting-off wheels, minimum flange diameter dₘᵢₙ is: dₘᵢₙ 37.5 mm for D≤250 mm, dₘᵢₙ=45 mm for 250 mm<D<300 mm, dₘᵢₙ=52.5 mm for 300 mm<D≤350 mm and dₘᵢₙ=60 mm for 350 mm<D. For abrasive cutting-off wheels, minimum flange diameter dₘᵢₙ is: dₘᵢₙ 63.5 mm for D≤250 mm, dₘᵢₙ=75 mm for 250 mm<D≤300 mm, dₘᵢₙ=87.5 mm for 300 mm<D≤350 mm and dₘᵢₙ=100 mm for 350 mm<D.

Maximum cutting depth tₘₐₓ achievable by cutting-off wheel 11 in a workpiece is then achieved if flange diameter d_{f} of flange 41 corresponds to minimum flange diameter dₘᵢₙ and no components of cutting-off machine 10 additionally limit the cutting depth. Maximum cutting depth tₘₐₓ is defined by half the difference between wheel diameter D of cutting-off wheel 11 and minimum flange diameter dₘᵢₙ of flange 41: tₘₐₓ=½*(D−dₘᵢₙ). In gas-powered cutting-off machines 10 and a diamond cutting-off wheel, maximum cutting depth tₘₐₓ is: tₘₐₓ=106.25 mm for D=250 mm, tₘₐₓ=127.5 mm for D=300 mm, tₘₐₓ=148.75 mm for D=350 mm and tₘₐₓ=170 mm for D=400 mm. In gas-powered cutting-off machines and an abrasive cutting-off wheel, maximum cutting depth tₘₐₓ is: tₘₐₓ=93.25 mm for D=250 mm, tₘₐₓ=112.5 mm for D=300 mm, tₘₐₓ=131.25 mm for D=350 mm and tₘₐₓ=150 mm for D=400 mm.

In addition to flange diameter d_{f} of flange 41, cutting depth t of cutting-off wheel 11 is defined by the outer contours of the components of cutting-off machine 10 in machining area 26 of safety guard 24. The outer contours include a first outer contour 54 of safety guard 24, a second outer contour 55 of supporting housing part 36 and a third outer contour 56 of belt drive 19. Outer contours 54, 55, 56 are designed in such a way that their maximum distances b from output axis 40 are at an outcut angle θ less than or equal to half of minimum flange diameter dₘᵢₙ. First outer contour 54 of safety guard 24 has a first maximum distance b₁ from output axis 40 in the outcut angle; second outer contour 55 of supporting housing 36 has a second maximum distance b₂ from output axis 40 in the outcut angle; and third outer contour 56 of belt drive 19 has a third maximum distance b₃ from output axis 40 in the outcut angle. The maximum distance of the outer contour from output axis 40 in outcut angle θ is defined as maximum distance b of a component.

The condition that maximum distance b₃ of belt drive 19 from output axis 40 is less than or equal to half of minimum flange diameter dₘᵢₙ must apply to all subcomponents of belt drive 19 in outcut angle θ. Belt drive 19 is made up of output disk 39, drive belt 38 and cover 15 in the area of output shaft 20. Output disk 39 has a fourth maximum distance b₄ from output axis 40 in outcut angle θ; drive belt 38 has a fifth maximum distance b₅ from output axis 40 in outcut angle θ; and cover 15 has a sixth maximum distance b₆ from output axis 40 in outcut angle θ.

Since drive belt 38 is situated on output disk 39 and, in the exemplary embodiment, output disk 39 does not project over drive belt 38, fourth maximum distance b₄ of output disk 39 from output axis 40 in the outcut angle is less than fifth maximum distance b₅ of drive belt 38. If the condition that the maximum distance in outcut angle θ is less than or equal to half of minimum flange diameter dₘᵢₙ is met for drive belt 38, the condition is also met for output disk 39. In an arbitrary design of output disk 39 and drive belt 38, the condition that the maximum distance in outcut angle θ is less than or equal to half of minimum flange diameter dₘᵢₙ must be met for output disk 39 and drive belt 38.

Cover 15 performs the function of covering belt drive 19, and it covers output disk 39 and drive belt 38 in the area of output shaft 20. In the exemplary embodiment, output disk 39 and drive belt 38 are completely covered by cover 15. If the condition that the maximum distance in outcut angle θ is less than or equal to half of minimum flange diameter dₘᵢₙ is met for cover 15, the condition is also met for output disk 39 and drive belt 38. In the exemplary embodiment, third maximum distance b₃ of belt drive 19 from output axis 40 corresponds to sixth maximum distance b₆ of cover 15 from output axis 40. In an arbitrary design of output disk 39, drive belt 38 and cover 15, the condition that the maximum distance in outcut angle is less than or equal to half of minimum flange diameter dₘᵢₙ must be met for cover 15, output disk 39 and drive belt 38.

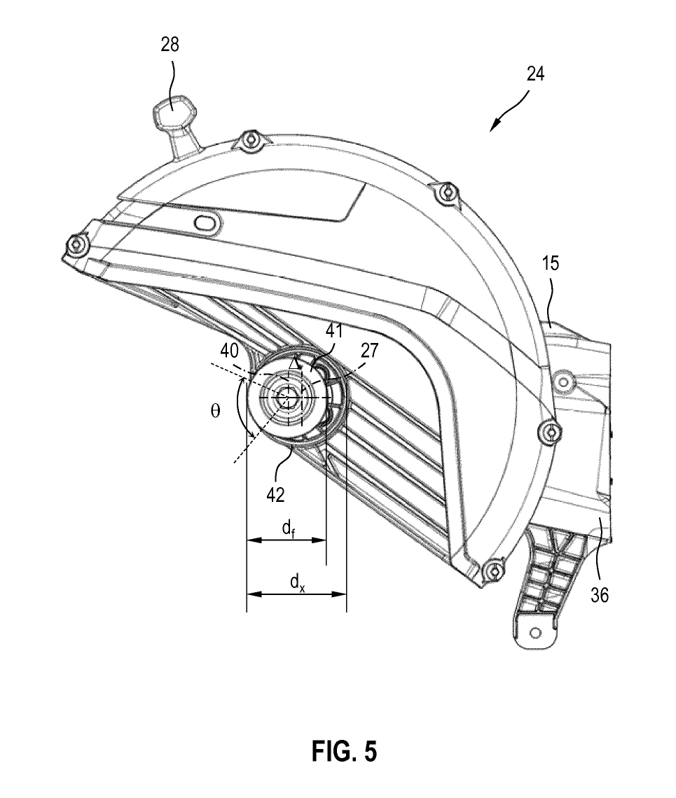

FIG. 5 shows safety guard 24 of cutting-off machine 10 without a cutting-off wheel 11 in a pivot position, which corresponds to the pivot position of safety guard 24 in FIG. 3A. Safety guard 24 is pivotably supported around pivot axis 27 with the aid of fastening flange 42 on stationary housing part 36. Fastening flange 42 has a circular design and a diameter dₓ. Diameter dₓ of fastening flange 42 is a variable which is essentially defined by the size and weight of safety guard 24.

Pivot axis 27 of safety guard 24 is different than output axis 40 of output shaft 20. Pivot axis 27 is displaced with respect to output axis 40 into covering area 25 of safety guard 24. The full angle of cutting-off wheel 11 of 360° is divided by safety guard 24 into the covering angle and the machining angle, the covering angle being approximately 200° and the machining angle being approximately 160°. Outcut angle θ is situated within the machining angle of cutting-off wheel 11 and, in the exemplary embodiment, is approximately 70°.

The support of safety guard 24 in outcut angle θ is particularly critical, due to the limited receiving area. Safety guard 24 includes fastening flange 42, which is mounted on counter-contour 44 of supporting housing part 36. If pivot axis 27 of safety guard 24 coincides with output axis 40 of output shaft 20, diameter dₓ of fastening flange 42 is limited by flange diameter d_{f}. The smaller the flange diameter d_{f} is selected, the smaller is the receiving area for arranging and supporting the components. If flange diameter d_{f} of flange 41 corresponds to minimum flange diameter dₘᵢₙ, the smallest receiving area is available for arranging and supporting the components.

Due to the displacement of pivot axis 27 into covering area 25 of safety guard 24, diameter dₓ of fastening flange 42 may be selected to be larger than flange diameter d_{f} of flange 41 used. Distance Δ between pivot axis 27 and output axis 40 is selected to be greater than or equal to half the difference between diameter dₓ of fastening flange 42 and flange diameter d_{f}. In this case, fastening flange 42 of safety guard 24 is situated in the receiving area, which is defined by flange diameter d_{f}.

What is claimed is:

1-9. (canceled)

10: A handheld, hand-guided cutting-off machine comprising:
a supporting housing part;
a cutting-off wheel having a wheel diameter;
an output shaft rotatably supported around an output axis on the housing part with the aid of a bearing element;
a drive motor and a transmission mechanism connecting the drive motor to the output shaft, the transmission mechanism being situated on the housing part;
a flange having a flange diameter, the cutting-off wheel being rotatably fixedly situatable on the output shaft with the aid of the flange; and
a safety guard having a covering area at least partially covering the cutting-off wheel, and a machining area exposing the cutting-off wheel, the safety guard being pivotably supported around a pivot axis on the housing part;
the pivot axis of the safety guard being displaced by a distance from the output axis of the output shaft.

11: The cutting-off machine as recited in claim 10 wherein the pivot axis is displaced with respect to the output axis into the covering area of the safety guard.

12: The cutting-off machine as recited in claim 11 wherein the safety guard includes a fastening flange having a diameter (dₓ), and the distance between the pivot axis and the output axis is greater than or equal to half the difference between the diameter (dₓ) of the fastening flange and the flange diameter.

13: The cutting-off machine as recited in claim 11 wherein the safety guard, having a first maximum distance (b₁), the supporting housing part having a second maximum distance (b₂) and the transmission mechanism has a third maximum distance (b₃) from the output axis over an outcut angle, wherein the first, second and third maximum distances (b₁, b₂, b₃) are less than half the flange diameter or equal to half the flange diameter.

14: The cutting-off machine as recited in claim 13 wherein the transmission mechanism includes an output disk situated on the output shaft, and a transmission element transmitting a movement of the drive motor to the output disk, the output disk having a fourth maximum distance (b₄) and the transmission element having a fifth maximum distance (b₅) from the output axis over the outcut angle, wherein the fourth and fifth maximum distances (b₄, b₅) are less than half the flange diameter or equal to half the flange diameter.

15: The cutting-off machine as recited in claim 14 wherein the transmission mechanism includes a cover, the cover having a sixth maximum distance (b₆) from the output axis over the outcut angle less than half the flange diameter or equal to half the flange diameter.

16: The cutting-off machine as recited in claim 10 wherein the flange diameter of the flange corresponds to a minimum flange diameter (dₘᵢₙ).

17: The cutting-off machine as recited in claim 16 wherein the drive motor is a combustion motor, and the cutting-off wheel is designed as a diamond cutting-off wheel or as an abrasive cutting-off wheel.

18: The cutting-off machine as recited in claim 16 wherein the drive motor is an electric motor, and the cutting-off wheel is designed as a diamond cutting-off wheel or as a bound, reinforced cutting-off wheel.
